(19) United States
(12) Patent Application Publication
(10) Pub. No.: US 2024/0402126 A1
(43) Pub. Date: Dec. 5, 2024

(54) SYSTEMS AND METHODS FOR PREDICTION OF MAGNETIC STRESS CALIBRATION & MATERIAL IDENTIFICATION FROM INSPECTION DATA

(71) Applicant: Baker Hughes Holdings LLC, Houston, TX (US)

(72) Inventor: David John Buttle, Oxfordshire (GB)

(21) Appl. No.: 18/667,593

(22) Filed: May 17, 2024

Related U.S. Application Data
(60) Provisional application No. 63/470,008, filed on May 31, 2023.

(51) Int. Cl. G01N 27/87; G01L 1/12; G01M 3/00; G01N 27/90; G01N 27/9013

(52) U.S. Cl. CPC G01N 27/87; G01L 1/127; G01M 3/005; G01N 27/902; G01N 27/9046; G01N 27/9086

(57) ABSTRACT

An inspection system is provided including one or more magnetic probes configured to acquire stress measurements at a plurality of points along a surface of a specimen, wherein the stress data is acquired at a plurality of angles for each of the plurality of points and a computing system communicatively coupled to the one or more magnetic probes, the computing system including at least one data processor and a memory storing a plurality of predetermined material calibration parameters and material properties for a plurality of materials and instructions which, when executed by the at least one processor, cause the at least one processor to receive, from the one or more magnetic probes, the stress measurements, compare the stress measurements to the material calibration parameters and material properties, determine material properties of the specimen based on the comparing and provide the material properties of the specimen to a user interface display.

### RELATED APPLICATION

This application claims priority under 35 U.S.C. § 119 (e) to U.S. Provisional Application No. 63/470,008 filed May 31, 2023, the entire contents of which are hereby expressly incorporated by reference herein.

### FIELD

The subject matter herein relates to systems and methods for determining stresses present in a material and identifying the material using inspection data.

### BACKGROUND

Conventional methods for extracting absolute biaxial stress levels from data acquired of a specimen (e.g., a pipe) include performing a calibration using a special sample of the material of the same grade as that of the specimen. Applied loads are used together with strain gauges to monitor the applied stress while measuring the magnetic properties as measured by probes of the system. The data is then fitted to a theoretical thermodynamic model which establishes the calibration for that steel type. These conventional systems and methods for determining stresses present in a material can require a user to have an astute understanding of the materials being analyzed as well as a thorough knowledge of the mathematical principles surrounding stress in materials.

### SUMMARY

In one aspect, an inspection system for determining material properties of and bi-axial stress in a specimen being inspected is provided. In some aspects, the inspection system can include one or more magnetic probes arranged to acquire stress data characterizing a plurality of stress measurements at a plurality of points along a surface of a specimen, wherein the stress data can be acquired at a plurality of angles for each of the plurality of points. In some aspects, the inspection system can also include a computing system communicatively coupled to the one or more magnetic probes, the computing system including at least one data processor and a memory storing material data characterizing a plurality of predetermined material calibration parameters and material properties for a plurality of materials and computer-readable instructions which, when executed by the at least one processor, cause the at least one processor to perform operations including: receiving, from the one or more magnetic probes, stress data characterizing a plurality of stress measurements along the surface of the specimen, comparing the stress data to the material data, determining material properties of the specimen based on the comparing and providing the material properties of the specimen to a user interface display communicatively coupled to the computing system.

In some aspects, the specimen can be a pipeline made from a ferromagnetic material. In this case, the inspection system can further include an in-line inspection unit arranged to move along the pipeline and the one or more magnetic probes can be coupled to the in-line inspection unit.

In some aspects, the one or more magnetic probes can include a plurality of probes arranged to acquire stress measurements across a range of at least 90 degrees. In some aspects, the one or more magnetic probes can include a singular probe arranged to rotate at least 90 degrees and acquire stress measurements at a plurality of angles along the surface of the pipeline.

In some aspects, each of the one or more magnetic probes can include a magnetic flux linkage sensor arranged to measure magnetic flux and a magnetic leakage sensor arranged to measure magnetic leakage.

In some aspects, the material data includes calibration data characterizing magnetic permeability and coercivity for each of the plurality of materials as a function of stress and a plurality of calibration stress measurements from the plurality of materials acquired across a known range of stresses, a known range of probe frequencies and a known range of probe distances.

In some aspects, the operations performed by the at least one processor can further include: determining a plurality of stress calibration parameters for the stress data based on the material data and the determined material properties, generating one or more interactive bi-axial stress maps characterizing bi-axial stress along the surface specimen based on the plurality of stress calibration parameters and the stress data and providing the one or more interactive bi-axial stress maps to the user interface display.

In some aspects, the operations performed by the at least one processor can further include determining a plurality of principal stress axes for a plurality of positions along the surface of the specimen based on the plurality of stress calibration parameters.

In some aspects, the one or more interactive stress maps can include data representative of the plurality of principal stress axes for a plurality of positions along the surface of the specimen based on the plurality of stress calibration parameters.

In some aspects, the operations performed by the at least one processor can further include: determining minimum, average and maximum biaxial stresses for a portion of the specimen being inspected and providing a stress table to the user interface display, wherein the stress table includes data characterizing the minimum, average and maximum biaxial stresses for the portion of the specimen and global principal stress axes characterizing a range of the plurality of principal stress axes for the plurality of positions along the surface of the specimen.

In another aspect, a method for determining material properties of and bi-axial stress in a specimen being inspected is provided. In some aspects, the method can include: acquiring, by one or more magnetic probes, stress data characterizing a plurality of stress measurements at a plurality of points along a surface of a specimen, wherein the stress data can be acquired at a plurality of angles for each of the plurality of points, receiving the stress data by a computing system including at least one data processor and a memory storing material data characterizing a plurality of predetermined material properties for a plurality of materials and computer-readable instructions which, when executed by the at least one processor, cause the at least one processor to perform operations, comparing, by the at least one data processor, the stress data to the material data, determining, by the at least one data processor, material properties of the specimen based on the comparing and providing, by the at least one data processor, the material properties of the specimen to a user interface display communicatively coupled to the computing system.

In some aspects, the specimen can be a pipeline made from a ferromagnetic material. In this case, the method can further include deploying an in-line inspection unit into the pipeline, wherein the in-line inspection unit can be arranged to move along the pipeline during an inspection and wherein the one or more magnetic probes can be coupled to the in-line inspection unit.

In some aspects, the one or more magnetic probes can include a plurality of probes arranged to acquire stress measurements across a range of at least 90 degrees along the surface of the pipeline. In some aspects, the one or more magnetic probes can include a singular probe arranged to rotate at least 90 degrees and acquire stress measurements at a plurality of angles along the surface of the pipeline.

In some aspects, each of the one or more magnetic probes include a magnetic flux linkage sensor arranged to measure magnetic flux and a magnetic leakage sensor arranged to measure magnetic leakage.

In some aspects, the material data includes calibration data characterizing magnetic permeability and coercivity for each of the plurality of materials as a function of stress and a plurality of calibration stress measurements from the plurality of materials acquired across a known range of stresses, a known range of probe frequencies and a known range of probe distances.

In some aspects, the method can further include: determining, by the at least one data processor, a plurality of stress calibration parameters for the stress data based on the material data and the determined material properties, generating, by the at least one data processor, one or more interactive stress maps characterizing stress along the surface specimen based on the plurality of stress calibration parameters and the stress data and providing, by the at least one data processor, the one or more interactive stress maps to the user interface display.

In some aspects, the method can further include determining, by the at least one data processor, a plurality of principal stress axes for a plurality of positions along the surface of the specimen based on the plurality of stress calibration parameters.

In some aspects, the one or more interactive stress maps can include data representative of the plurality of principal stress axes for a plurality of positions along the surface of the specimen based on the plurality of stress calibration parameters.

In some aspects, the method can further include: determining, by the at least one data processor, minimum, average and maximum biaxial stresses for a portion of the specimen being inspected and providing, by the at least one data processor, a stress table to the user interface display, wherein the stress table includes data characterizing the minimum, average and maximum biaxial stresses for the portion of the specimen and global principal stress axes characterizing a range of the plurality of principal stress axes for the plurality of positions along the surface of the specimen.

### BRIEF DESCRIPTION OF THE DRAWINGS

These and other features will be more readily understood from the following detailed description taken in conjunction with the accompanying drawings, in which:

FIG. 1 is a diagram illustrating an exemplary aspect of a system (Magnetic Anisotropy and Permeability System (MAPS)) for determining a material of a specimen (e.g., a pipe) being inspected and for determining bi-axial stress along the surface of a specimen;

FIG. 2 is a diagram illustrating an exemplary probe, a plurality of which can be used in a MAPS as described herein (e.g., the MAPS of FIG. 1);

FIG. 3 is an isometric view of another an exemplary aspect of a MAPS as described herein;

FIG. 4 is an exemplary cosine fitting operation that can be performed on the stress measurements acquired by the linkage and leakage sensors of each probe (e.g., probes of FIG. 1) for a given point along the surface of the pipe;

FIG. 5 is an exemplary graph illustrating a library of calibration data representative of a plurality of predetermined average linkage parameters plotted against a plurality of predetermined average leakage parameters for a plurality of pipe materials (e.g., steel grades), which are stored within the memory of the system;

FIG. 6 is an exemplary graph illustrating a library of calibration data representative of a plurality of predetermined linkage peak-to-peak parameters plotted against a plurality of predetermined leakage peak-to-peak parameters for the plurality of pipe materials which are stored within the memory of the system;

FIG. 7 is an exemplary predetermined/interpolated biaxial average stress calibration map illustrating an interpolated biaxial average stress calibration for a specimen of known/unknown material being inspected by the systems and methods described herein;

FIG. 8 is an exemplary predetermined/interpolated biaxial peak-to-peak stress calibration map illustrating reconstructed biaxial stress calibration for a specimen of known/unknown material being inspected by the systems and methods described herein;

FIG. 9 is an exemplary full calibration map for a specimen being inspected which includes an overlay of the predetermined/interpolated biaxial average stress calibration map of FIG. 7 and the predetermined/interpolated biaxial peak-to-peak stress map of FIG. 8;

FIG. 10 is an exemplary interactive axial stress map characterizing axial stress along a portion of the surface specimen being inspected;

FIG. 11 is an exemplary interactive circumferential stress map characterizing circumferential stress along a portion of the surface specimen being inspected;

FIG. 12 is an exemplary interactive bi-axial stress map characterizing bi-axial stress along a portion of the surface specimen being inspected;

FIG. 13 is an exemplary interactive lift map characterizing changes in distance (e.g., in microns) from the plurality of probes of the system to a surface of a pipe being inspected;

FIG. 14 is an exemplary stress table that can also be provided to the user interface (UI) display of the system to be viewed by the user;

FIG. 15 is a block diagram of a computing system suitable for use in implementing the computerized components as described herein;

It is noted that the drawings are not necessarily to scale. The drawings are intended to depict only typical aspects of the subject matter disclosed herein, and therefore should not be considered as limiting the scope of the disclosure.

### DETAILED DESCRIPTION

Conventional systems and methods for determining stresses present in a specimen of a given material (e.g., a pipe of a pipeline system) can require a user to acquire a sample of the material and conduct time intensive calibration testing on the material before being able to carry out an inspection of the actual specimen. This can require an astute understanding of material testing, including a thorough knowledge of the mathematical principles surrounding stress in materials and such material specific calibration prior to inspection can be time and cost prohibitive. Additionally, conventional systems are only capable of providing information regarding the bi-axial stress and strain in a material, without providing any information in regard to the material itself. This can be problematic, for example, in pipeline inspection when a pipeline operator may not know the material of the pipe being inspected and may not be able to get a sample of it, resulting in an inability to determine accurate bi-axial stress and strain in the unknown material.

The systems and methods provided herein address the aforementioned shortcomings by leveraging direct stress measurements from a specimen (e.g., a pipe) acquired using Magnetic Anisotropy and Permeability Systems (MAPS) along with predetermined material properties to determine the material properties of the specimen as well as a comprehensive bi-axial stress map for the stresses within the specimen. By calibrating the stress measurements with predetermined material properties stored within the memory of the system, the systems and methods described herein are capable of determining the material properties and bi-axial stress of the specimen even if the material of the specimen unknown (e.g., by way of accurate interpolation), as described in greater detail below.

For example, in some aspects, the system described herein can include a MAPS including one or more probes, each having particularly arranged sensors arranged to acquire a series of measurements of a specimen (e.g., a pipe) at a series of positions along the specimen. In the case where the specimen is a pipe, the system can measure biaxial stress by continuously measuring the magnetic properties inside of the pipe using an in-line inspection unit (e.g., a Pipeline Inspection Gauge (PIG)) during an inspection. The data acquired by the PIG can be used by the system, in combination with a library of predetermined calibration data, to directly predict a stress calibration, and therefore the material of the pipe being inspected in real-time and/or after an inspection operation, by uploading the inspection data to an external computing device. In some cases, the library of predetermined calibration data can include a variety of stress and strain data specific to a variety of materials, for example, in the form of stress maps and/or diagnostic plots, as discussed in greater detail below. The system can then use the stress calibration and the material identification to accurately determine the stress at continuous points within the pipe and provide that information to the user.

The systems and methods described herein advantageously remove the need for time and cost prohibitive laboratory work and instead provide a system capable of using a specimen (e.g., a pipe) itself to perform stress calibration and material identification in real-time. The determined stress calibration and material identification can be used by the system to contextualize the data acquired during inspection and provide the user with comprehensive bi-axial stress information for all points in the specimen. Accordingly, the systems and methods described herein are capable of identifying unknown or uncertain steel grades in real-time, during the inspection. The systems and methods described herein further enable more accurate estimations of various valuable parameters, for example the Maximum Allowable Operating Pressure (MAOP) in a pipe, a parameter that can advantageously be used to reduce unnecessary conservatism.

In ferromagnetic materials (e.g. ferritic steels), magnetic interaction between neighboring atomic moments in the lattice structure of the materials is sufficient to align them into magnetic domains, the size of these domains being an energy minimization between magnetostatic and magneto-crystalline anisotropy energy. This atomic interaction results in a small lattice strain (e.g., ˜10 με), known as magnetostriction, which is positive in steel. When external forces are applied to these materials, the angular distribution (direction) of the magnetic domain's changes by the movement of the domain boundaries, such that a fraction of domains aligned along the maximum stress axis increases while that along the minimum stress axis decreases, reducing the total elastic energy within the volume. Consequently, application of an external magnetic field more readily magnetizes (aligns) the domains when it is applied along the tensile stress axis, and thus the magnetic permeability is higher in this direction. Conversely the permeability is reduced when the field is applied along the minimum stress direction. Accordingly, magnetic properties for these materials are functions of the stress tensor, and changes in these magnetic signatures can be used to deduce the underlying state of stress, as described in greater detail below.

The systems and methods described herein can be used to determine stress in a wide range of industries including oil and gas pipelines, aerospace applications, automotive applications, rail-way applications, power generation applications (e.g., nuclear, coal, wind), steel manufacturing applications and more.

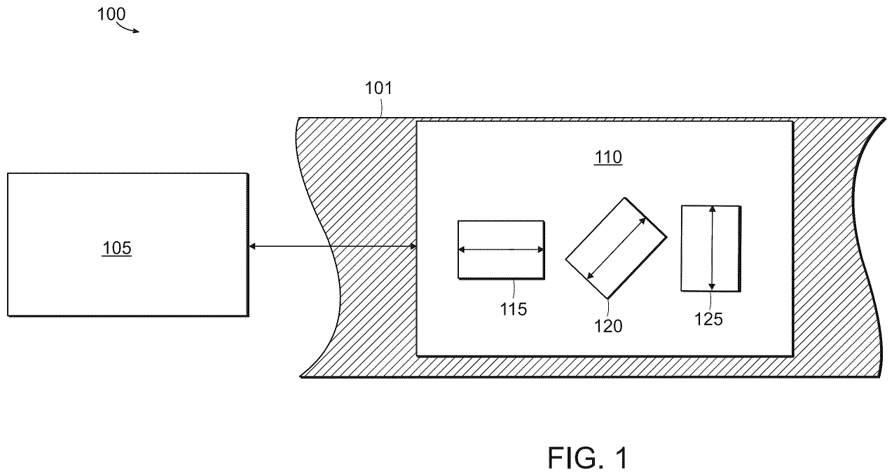

FIG. 1 is a diagram illustrating an exemplary aspect of a system 100 for determining a material of a specimen (e.g., pipe 101) being inspected and for determining bi-axial stress along the surface of a specimen. In some aspects, the system 100 can include a computing system 105, which can further include at least one processor, and a memory, as discussed in greater detail below. The system 100 can also include a MAPS 110, including one or more probes 115, 120, 125, each having particularly arranged sensors (e.g., arranged at different angles) to acquire a series of measurements of a specimen (e.g., a pipe) at a series of positions along the specimen. For example, as shown in FIG. 1, probe 115 can be positioned at 0° relative to an axial direction of the pipe 101, probe 120 can be positioned at 45° relative to the axial direction, and probe 125 can be positioned at 90° relative to the axial direction (e.g., parallel to a radial/circumferential direction of the pipe 101). In this case, the MAPS 110 can be configured to move along an interior or exterior of the pipe 101, while each probe 115, 120, 125 acquires stress measurements at each point along the pipe 101. The stress measurements acquired by the MAPS 110 can be analyzed by the computing system 105 to determine the material/material properties of the pipe 101, which can be in turn used to determine accurate biaxial stress profiles for each point along the pipe, as described in greater detail below. In some aspects, the MAPS 110 can include a single probe (not shown) configured to rotate about an axis during an inspection and acquire a series of measurements at the different angles of orientation indicated by the plurality of probes 115, 120, 125. In some aspects, the MAPS 110 can be a component of a larger PIG system configure to perform a comprehensive inspection of the specimen 101, as described in greater detail below.

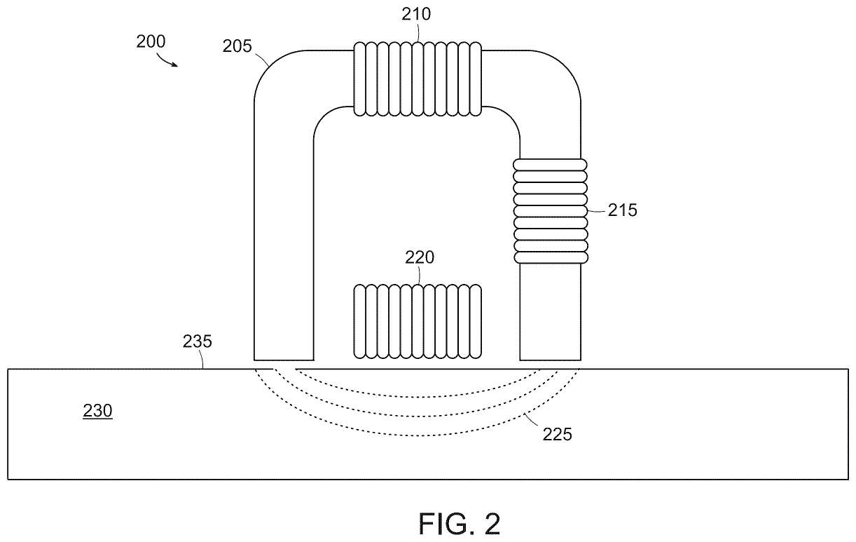

FIG. 2 is a diagram illustrating an exemplary probe 200, a plurality of which can be used in a MAPS as described herein (e.g., MAPS 110 of FIG. 1). In some aspects, the probe 200 can be similar to probes 115, 120 and 125 of FIG. 1. In some aspects, the probe 200 can include a body 205, an excitation sensor 210, a linkage sensor 215, and a leakage sensor 220. The probe 200 can be used to collect voltage/impedance measurements of a specimen 230 (e.g., a pipe) using a magnetic field 225. In some aspects, the probe 200 can be configured to measure biaxial stress on the surface 235 of the specimen 230 along its principal axes. In some aspects, (in a case where the specimen is a pipeline) the biaxial stress can include the circumferential stress and the axial stress. However, in some cases, the biaxial stress can have different principal axes. The linkage sensor 215 and the leakage sensor 220 can both have material property sensitivity, but can each have a different proportion of stress and material grade sensitivity (e.g., magnetic permeability as a function of stress, coercivity as a function of stress, yield strength, or other material properties). These different proportions can allow these two factors to be separated explicitly. In some aspects, the data collected from the linkage sensor 215 and the leakage sensor 220 of each of a plurality of probes 200 (e.g., probes 115, 120 and 125 of FIG. 1) can be transmitted to a processor of a computing system to be analyzed. In some aspects, the processor can be configured to fully remove lift-off sensitivity from the data collected from the linkage sensor 215 and the leakage sensor 220 of each of a plurality of probes 200 (lift-off being determined, for example, in microns). The linkage sensor 215 and the leakage sensor 220 both exhibit the same functional response to changes in stress in the material. Accordingly, the processor can also be configured linearly correlate the data from the linkage sensor 215 with the data from the leakage sensor 220 in a plot to determine a plurality of parameters that are necessary to accurately determine the material properties and bi-axial stress at continuous points within the pipe, and provide that information to the user, as described in greater detail below.

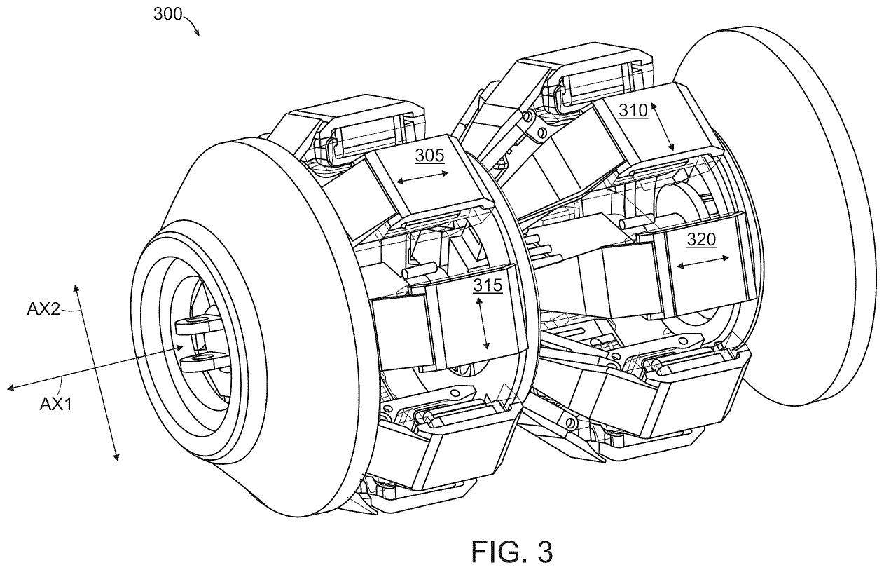

FIG. 3 is an isometric view of another an exemplary aspect of a Magnetic Anisotropy and Permeability System (MAPS) 300. In some aspects, as shown in FIG. 3, the MAPS 300 can include a plurality of probes 305, 310, 315, 320 (and additional probes shown but not labeled in FIG. 3) each having particularly arranged sensors arranged to acquire a series of measurements of a specimen (e.g., a pipe) at a series of positions along the specimen. For example, as shown in FIG. 3, probes 305 and 310 can be positioned parallel to a direction of movement of the MAPS 300 (e.g., an axial direction AX1 of a pipeline). Probes 315 and 320 can be positioned perpendicular to a direction of movement of the MAPS 300 (e.g., parallel to a radial/circumferential direction AX2 of the pipeline). While the probes of FIG. 3 are oriented parallel to the axial and circumferential directions, it should be noted that they could be oriented at any angles relative to the axial and circumferential directions of the pipeline. In this case, the MAPS 300 can be configured to move along an interior or exterior of a pipe, while each of the plurality of probes acquires stress measurements at each point along the pipe which can be analyzed by the computing systems described herein, similarly to as described above in reference to FIG. 1.

In some aspects, the MAPS 300 can form a section of a larger Pipeline Inspection Gauge (PIG) system configured to inspect a pipeline system. In some cases, the PIG system can include a variety of other Nondestructive Examination (NDE) tools/techniques configured to inspect the pipeline. NDE techniques that could be used in the system can include those capable of reliable detection and characterization of physical flaws of defined types in the item under inspection. Such features can be volumetric (such as corrosion/gouging), deformation (dents, roundness), cracking (all forms and locations), localized abnormalities of material (hard spots, laminations, inclusions), manufacturing construction issue (misalignments), pipeline geometry (roundness, centerline path). In pipelines, for example, NDE tools/techniques that could be used in the PIG system, alongside the MAPS can include: Magnetic Flux Leakage (MFL) inspection, Electromagnetic Acoustic Transducers (EMAT), caliper, UT piezo Phased Arrays (gas or liquid), X-ray, active and passive eddy current, etc.

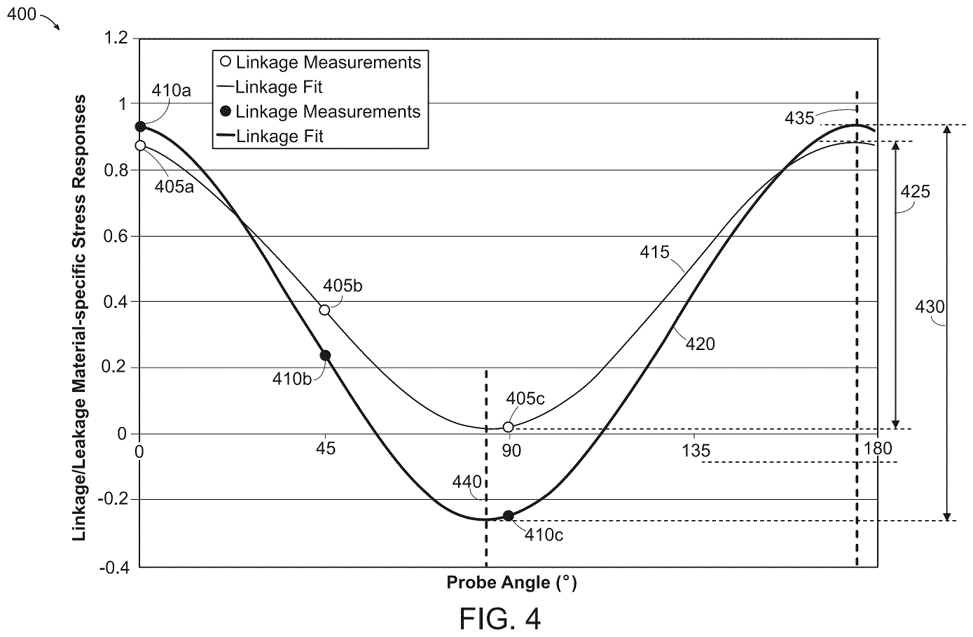

FIG. 4 is an exemplary cosine fitting operation 400 that can be performed on the stress measurements acquired by the linkage and leakage sensors of each probe (e.g., probes 115, 120 and 125 of FIG. 1) for a given point along the surface of the pipe. The cosine fitting operation 400 can be used to determine the principal axes of stress (the angles where the maximum and minimum stress occur) for that point in the pipe. By performing the cosine fitting operation 400 for a plurality of points in the pipe, it is also possible to determine material-specific calibration parameters that can be used by the system to determine the material/material properties of the pipe, as will be described in greater detail below. The cosine fitting operation 400 as shown in FIG. 4 will be described below for using stress measurements from a single point along a surface of a pipe, however, it should be noted that the cosine fitting operation 400 can be used to determine the principal axes of stress and material/material properties of the pipe across all points within the pipe.

For example, during an inspection operation of a pipeline using the system of FIG. 1, one or more processors of the computing system 105 can be configured to receive stress measurements (e.g., voltages) from the probes 115, 120 and 125 at each position along the pipe. The system can process the stress measurements, perform any necessary temperature corrections and compare the in-phase and quadrature (I-Q) components of the stress measurements to a library of predetermined linkage sensor and leakage sensor stress calibration data for a plurality of ferromagnetic pipe materials stored within the memory of the system. Based on the comparing, the system can extract the material-specific stress responses from the non-material-specific lift responses for the linkage and leakage sensors which can be used during the cosine fitting operation 400, as described herein. In some aspects, the library of predetermined linkage sensor and leakage sensor stress calibration data for the plurality of pipe materials can be determined by acquiring various stress measurements of samples of the plurality of pipe materials under a wide range of stresses using probes like the probes 115, 120 and 125. For example, the predetermined stress calibration data can include stress measurements acquired across a wide range of probe frequencies, probe distances and known material stresses. This library of predetermined calibration data, including relationships between material-specific stress responses and non-material-specific (e.g., lift) responses for the plurality of pipe materials can be stored in the memory of the system. Accordingly, the system can compare the stress measurements acquired during the inspection to the predetermined calibration data to interpolate and extract the material-specific stress responses for the pipe to identify the pipe material and the bi-axial stress for all points in the pipe, as described in greater detail below. It should be noted that, in a case where it can be assumed that the biaxial stress within the pipe is occurring on the axial and circumferential axes of the pipe, the system can be configured to directly determine the axial and circumferential stress from the stress measurements acquired by the linkage and leakage sensors of each probe for a given point along the surface of the pipe. In this case, only two probes are necessary for the inspection Additionally, in some aspects, the systems and methods described herein can include a singular probe configured to rotate 360 degrees and acquire measurements at a plurality of angles (e.g., every 22.5 degrees).

Once the system has extracted the material-specific stress responses from the non-material-specific lift responses for the linkage and leakage sensors of each probe 115, 120 and 125 for a given position along the pipe, the system can be configured to begin the cosine fitting operation 400. For example, points 405a, 405b, 405c, as shown in FIG. 4, correspond to material-specific linkage stress responses for the linkage sensors of probes 115, 120, 125, respectively. In this case, probe 115 is positioned at 0° (axial direction), probe 120 is positioned at 45°, and probe 125 is positioned at 90° (radial/circumferential direction). As described above, the raw stress measurements acquired by the linkage sensors of probes 115, 120, 125 can include both a material-specific stress response component and a non-material-specific lift response component. The points 405a, 405b, 405c can be the material-specific stress response components of the raw measurements, which are extracted from the non-material-specific lift response components by the system prior to executing the cosine fitting operation. Similarly, points 410a, 410b, 410c correspond to material-specific leakage stress responses for the leakage sensors of probes 115, 120, 125, respectively. Based on the points 405a, 405b, 405c and points 410a, 410b, 410c, the system can be configured to determine a linkage fit 415 and a leakage fit 420. Based on the linkage fit 415 and the leakage fit 420, the system can be configured to determine an average linkage parameter (not shown), an average leakage parameter (not shown), a linkage peak-to-peak parameter 425 and a leakage peak-to-peak parameter 430. The average linkage parameter is defined as the average of the linkage fit 415 and the average leakage parameter is defined as the average of the leakage fit 420. In some aspects, the average linkage parameter can also be referred to as the permeability material delta. The average leakage height parameter can also be referred to as the average flux leak coil material delta. The linkage peak-to-peak parameter 425 is defined as the peak-to-peak distance of the linkage fit 415 and the leakage peak-to-peak parameter 430 is defined as the peak-to-peak distance of the leakage fit 420. Additionally, based on the linkage fit 415 and the leakage fit 420, the system can be configured to determine principal stress axes 435, 440 for the bi-axial stress at that point in the pipe. For example, based on the cosine fitting operation 400, the system can determine that the principal stress axes 435, 440 for the bi-axial stress at the point in the pipe being inspected are approximately 175° and 85° from the axial direction of the pipe (e.g., the principal stress axes 435, 440 are offset from the axial and circumferential directions off the pipe by −5°.

In some aspects, the average linkage parameter, average leakage parameter, linkage peak-to-peak parameter 425, leakage peak-to-peak parameter 430 and principal stress axes 435, 440 can be used, together with the library of predetermined calibration data for the plurality of pipe materials stored within the memory of the system, to determine the bi-axial stresses (maximum and minimum) along with the material/material properties for that point in the pipe, as described in greater detail below. Similarly, if the material of the pipe being inspected is known, the average linkage parameter, average leakage height parameter, linkage peak-to-peak parameter 425, leakage peak-to-peak parameter 430 and principal stress axes 435, 440 can be used, together with the known material properties, to determine the bi-axial stresses for that point in the pipe. This operation can be performed for every point along the pipe. For example, as the MAPS (e.g., MAPS 110 of FIG. 1) moves through an inspection, each probe 115, 120 and 125 can be configured to acquire stress measurements for each point along the pipe (in some cases hundreds or thousands of points), which can be stored in a memory of the computing system, as discussed in greater detail below.

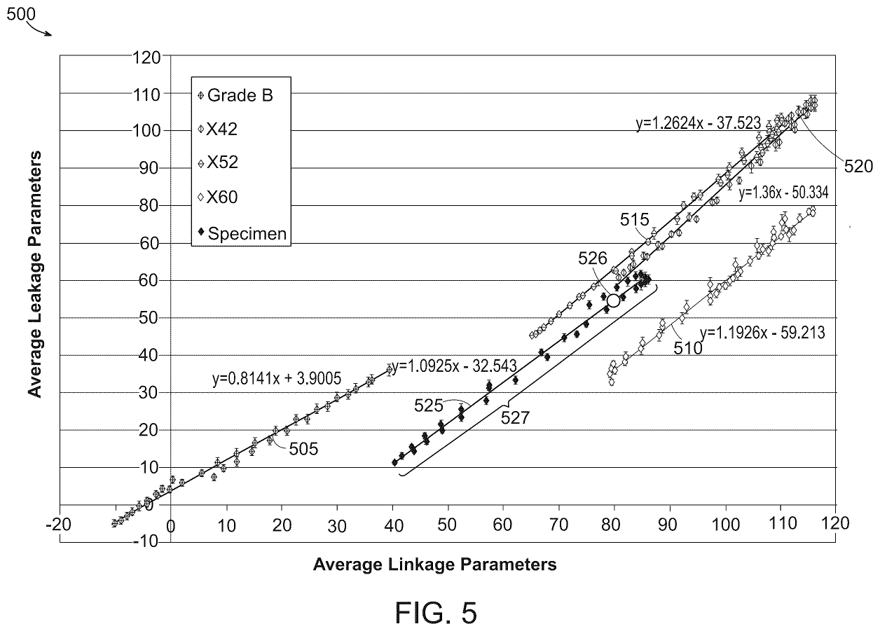

FIG. 5 is an exemplary graph 500 illustrating a library of calibration data representative of a plurality of predetermined average linkage parameters plotted against a plurality of predetermined average leakage parameters for a plurality of pipe materials (e.g., steel grades) as plots 505, 510, 515, 520 and stored within the memory of the system. As shown in FIG. 5, in some aspects, the average linkage parameters and average leakage parameters can be converted into percentages. In some aspects, for example, the calibration data of graph 500 can include predetermined linkage and leakage parameters for a plurality of American Pipeline Institute (API) steels used in pipelines. In some aspects, the predetermined linkage and leakage parameters plotted in plots 505, 510, 515, 520 can be determined using the cosine fitting operation 400 of FIG. 4 on laboratory stress measurements from the plurality of API steels acquired across a wide range of probe frequencies, probe distances and known material stresses, similarly to as described above. For example, in some aspects, the laboratory stress measurements can be acquired using probe frequencies of 84 Hz, 252 Hz, 750 Hz, 1950 Hz, or any other viable frequency.

Accordingly, each point on each plot 505, 510, 515, 520 corresponds to a single point within a piece of pipe acquired at a predetermined probe frequency as the pipe is under stress. While the graph 500 only shows plots 505, 510, 515, 520, it should be noted that the library of calibration data can include hundreds or thousands of points for numerous materials under different stress profiles, acquired across a wide range of probe frequencies. For each plot 505, 510, 515, 520, a plurality of linear fittings can be made to fit the plots, as shown in FIG. 5. Additionally, the library of calibration data can further include material properties for each of the plurality of pipe materials of plots 505, 510, 515, 520 (e.g., magnetic permeability as a function of stress, coercivity as a function of stress, yield strength, or other material properties). Additionally, in some aspects, the maximum and minimums of plots 505, 510, 515, 520 can be related to the maximum and minimum stresses that can be experienced by each material.

In some aspects, as the MAPS (e.g., MAPS 110 of FIG. 1) moves through the inspection and acquires stress measurements for each point along the pipe, the system can be configured to plot the average linkage parameters and average leakage parameters, determined using the cosine fitting operation 400 of FIG. 4 for each point along the pipe, as shown in plot 525 of FIG. 5. For example, for a single point in the pipe, the plot 525 can include a point 526 corresponding to the average linkage parameter and average leakage parameter at that point. Similarly to plots 505, 510, 515, 520, the system can be configured to determine a linear fitting for plot 525 based on the data. Once the system determines the linear fitting for plot 525, the system can compare the parameters of the plot 525 to the parameters of plots 505, 510, 515, 520 and the material properties for each of the plurality of pipe materials of plots 505, 510, 515, 520 to interpolate material properties for the pipe being inspected. For example, if the plot 525 were to fall directly on plot 515, then the system would determine that the pipe being inspected has the same material properties (e.g., yield stress and any other relevant material properties) as the material represented by plot 515 (e.g., API steel grade X52). Alternatively, if the plot 525 does not fall directly on another plot within the library of calibration data, as shown in FIG. 5, then the system can be configured to interpolate average stress calibration parameters by determining a weight of various plots (e.g., plots 505, 510, 515, 520) that are proximal to the plot 525. The system can use the weights determined to generate interpolated stress calibration parameters to be applied to the data. The interpolated average stress calibration parameters can include, for example, a yield stress of the material, a stress scale (e.g., to quantify the actual stress present in the pipe), an average linkage parameter range 527 (e.g., from a minimum of the plot 525 to a maximum of the plot 525) and any other relevant material properties. In both cases described above, the system can be configured to identify the material (or the material properties) of the specimen based on the assigned predetermined average stress calibration or the interpolated average stress calibration. The system can use the assigned predetermined average stress calibration or the interpolated average stress calibration to reconstruct a biaxial average stress map for the inspection of the specimen, as discussed in greater detail below.

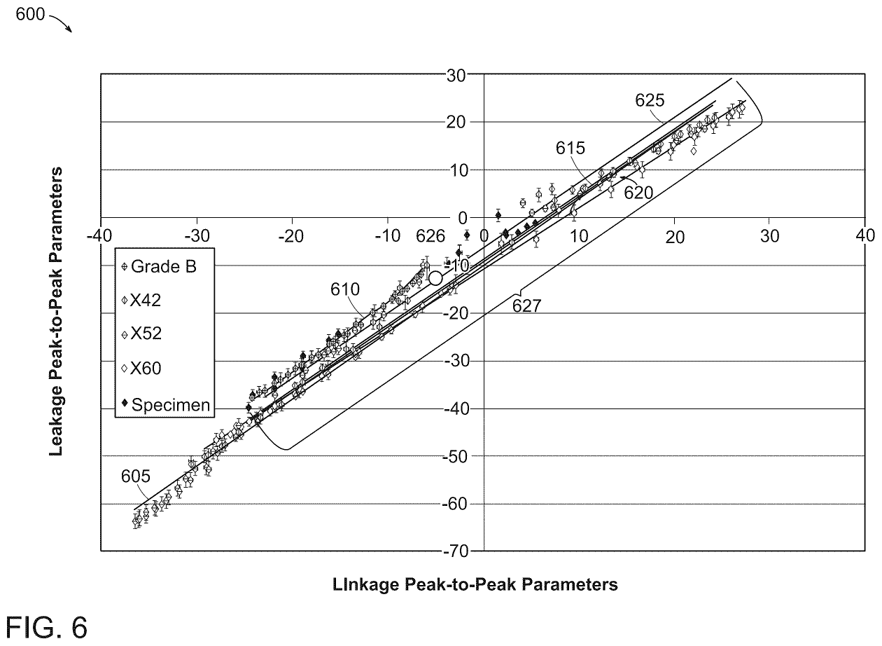

Similar to FIG. 5, FIG. 6 is an exemplary graph 600 illustrating a library of calibration data representative of a plurality of predetermined linkage peak-to-peak parameters plotted against a plurality of predetermined leakage peak-to-peak parameters for the plurality of pipe materials. In some aspects, the predetermined linkage/leakage peak-to-peak parameters for the plurality of pipe materials can be plotted as plots 605, 610, 615, 620 and stored within the memory of the system, similarly to as described above in reference to FIG. 5. As shown in FIG. 6, the linkage/leakage peak-to-peak parameters can be converted into percentages in the graph 600. The plots 605, 610, 615, 620 can also be determined using the cosine fitting operation 400 of FIG. 4 on laboratory stress measurements from the plurality of API steels acquired across a wide range of probe frequencies, probe distances and known material stresses, similarly to as described above. Accordingly, each point on each plot 605, 610, 615, 620 corresponds to a single point within a piece of pipe acquired at a predetermined probe frequency as the pipe is under stress. While the graph 600 only shows plots 605, 610, 615, 620, it should be noted that the library of calibration data can include hundreds or thousands of points for numerous materials under different stress profiles, acquired across a wide range of probe frequencies. For each plot 605, 610, 615, 620, a plurality of linear fittings can be made to fit the plots, as shown in FIG. 6. In some aspects, the maximum and minimums of plots 605, 610, 615, 620 can be related to the maximum and minimum stresses that can be experienced by each material.

As the MAPS (e.g., MAPS 110 of FIG. 1) moves through the inspection and acquires stress measurements for each point along the pipe, in addition to the plot 525 of FIG. 5, the system can also be configured to plot the linkage/leakage peak-to-peak parameters for each point along the pipe, as shown in plot 625 of FIG. 6 and determine a linear fitting for the plot 625. For example, for a single point in the pipe, the plot 625 can include a point 626 corresponding to the linkage and leakage peak-to-peak parameters at that point. The system can also perform similar comparing and interpolation operations, as described in reference to FIG. 5, on the linkage/leakage peak-to-peak parameters to determine a predetermined peak-to-peak stress calibration or an interpolated peak-to-peak stress calibration to be applied to the data. The interpolated peak-to-peak stress calibration can include, for example, a yield stress of the material, a stress scale (e.g., to quantify the actual stress present in the pipe), an linkage peak-to-peak parameter range 627 (e.g., from a minimum of the plot 625 to a maximum of the plot 625) and any other relevant material properties. In both cases described above, the system can be configured to identify the material (or the material properties) of the specimen based on the assigned predetermined peak-to-peak stress calibration or the interpolated peak-to-peak stress calibration. The system can use the assigned predetermined peak-to-peak stress calibration or the interpolated peak-to-peak stress calibration to reconstruct a biaxial peak-to-peak stress map for the inspection of the specimen, as discussed in greater detail below.

In some aspects, the predetermined/interpolated average stress calibration determined as described above in reference to FIG. 5 and the predetermined/interpolated peak-to-peak stress calibration determined as described above in reference to FIG. 6 can be used to reconstruct a full biaxial stress calibration for the inspection of pipe of a known or unknown material/material grade, as described below.

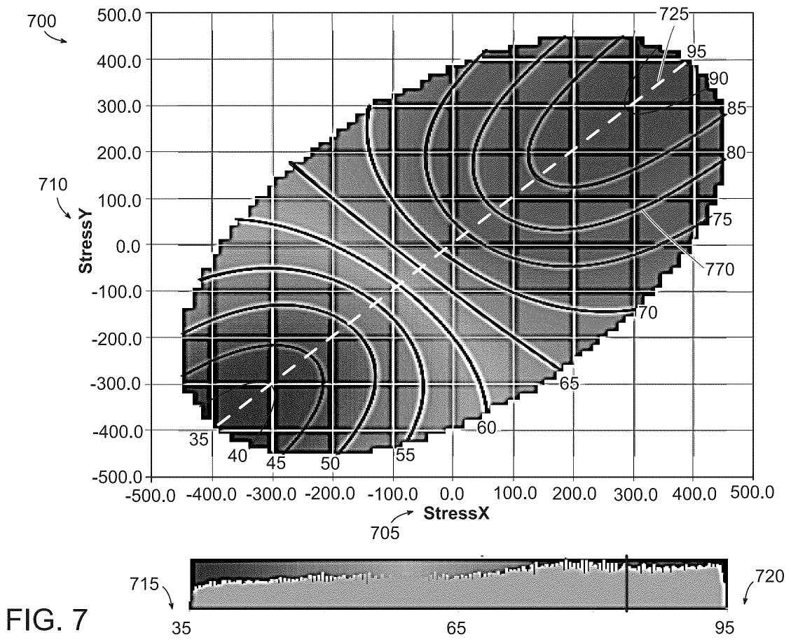

FIG. 7 is an exemplary predetermined/interpolated biaxial average stress calibration map 700 illustrating an interpolated biaxial average stress calibration for a specimen of known/unknown material being inspected by the systems and methods described herein. For example, in the case where the specimen being inspected is the pipe, as described above, the system can be configured to generate the map 700 for the pipe based on the predetermined/interpolated average stress calibration parameters determined using the average linkage/leakage parameters determined and the library of calibration data, as described above in reference to FIG. 5. As shown in FIG. 7, the map 700 can include a first principal axis 705 (e.g., “Stress X”) and a second principal axis 710 (e.g., “Stress Y”), a minimum average linkage parameter 715 and a maximum average linkage parameter 720. In some aspects, the stress ranges defined by the first principal axis 705 and the second principal axis 710 and the minimum and maximum average linkage parameters 715, 720, respectively, can be determined based on the stress measurements acquired and the material/material properties that are determined for the pipe (e.g., the maximum and minimum stresses that can be experienced by the pipe material determined). For example, the minimum and maximum average linkage parameters 715, 720 can be determined based on the average linkage parameter range 527 of FIG. 5, with the minimum average linkage parameter 715 corresponding to the minimum of the range 527 and the maximum average linkage parameter 720 corresponding to the maximum of the range 527. Additionally, the first principal axis 705 and the second principal axis 710 can represent stresses along the principal stress axes for the bi-axial stress at that point in the pipe (e.g., principal stress axes 435, 440 of FIG. 4, respectively). As illustrated in FIG. 7, the map 700 is symmetrical about a diagonal axis 725 and includes a plurality of contour lines 730-780. In some aspects, the range of the contour lines (e.g., from 40-90) can be determined based on the average linkage parameter range 527 of FIG. 5. Furthering the example described above in reference to FIGS. 4-6, as the MAPS (e.g., MAPS 110 of FIG. 1) moves through the inspection and acquires stress measurements, the average linkage component of each point (e.g., the average linkage component of point 526 of FIG. 5) can fall on a specific contour line (e.g., contour line 770) corresponding to that average linkage component (e.g., 80%). While FIG. 7 only shows contour lines 730-780 it should be noted that the biaxial average stress map 700 can include many contour lines covering the average linkage parameter range 527 (e.g., the range of the minimum and maximum average linkage parameters 715, 720).

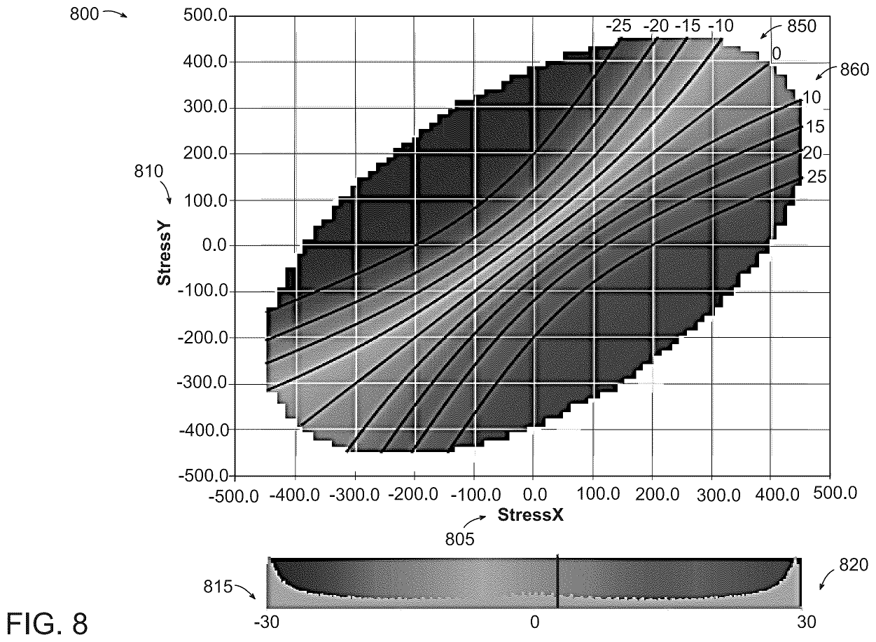

Similar to FIG. 7, FIG. 8 is an exemplary predetermined/interpolated biaxial peak-to-peak stress calibration map 800 illustrating reconstructed biaxial stress calibration for a specimen of known/unknown material being inspected by the systems and methods described herein. Similar to map 700, the system can be configured to generate the map 800 for the pipe based on the predetermined/interpolated peak-to-peak stress calibration determined using the linkage/leakage peak-to-peak parameters determined and the library of calibration data, as described above in reference to FIG. 6. As shown in FIG. 8, the map 800 can include a first principal axis 805 (e.g., “Stress X”) and a second principal axis 810 (e.g., “Stress Y”), which are the same as the first principal axis 705 and the second principal axis 710 of FIG. 7. The map 800 can also include a minimum peak-to-peak parameter 815 and a maximum peak-to-peak parameter 820. In some aspects, the stress ranges defined by the first principal axis 805 and the second principal axis 810 and the minimum and maximum peak-to-peak parameters 815, 820, respectively, can be determined based on the stress measurements acquired and the material/material properties that are determined for the pipe (e.g., the maximum and minimum stresses that can be experienced by the pipe material determined). For example, the minimum and maximum peak-to-peak parameters 815, 820 can be determined based on the linkage peak-to-peak parameter range 627 of FIG. 6, with the minimum peak-to-peak parameter 815 corresponding to the minimum of the range 627 and the maximum peak-to-peak parameter 820 corresponding to the maximum of the range 627. As illustrated in FIG. 8, the map 800 includes a plurality of contour lines 830-870 and is anti-symmetrical about a diagonal axis parallel to contour line 860. In some aspects, the range of the contour lines (e.g., from −25-25) can be determined based on the linkage peak-to-peak parameter range 627 of FIG. 6. Furthering the example described above in reference to FIGS. 4-7, as the MAPS (e.g., MAPS 110 of FIG. 1) moves through the inspection and acquires stress measurements, the linkage peak-to-peak component of each point (e.g., the linkage peak-to-peak component of point 626 of FIG. 6) can fall on a specific contour line (e.g., contour line 860) corresponding to that linkage peak-to-peak component (e.g., −5%). While FIG. 8 only shows contour lines 830-870 it should be noted that the biaxial peak-to-peak stress map 800 can include many contour lines covering the linkage peak-to-peak parameter range 627 (e.g., the range of the minimum and maximum peak-to-peak parameters 815, 820).

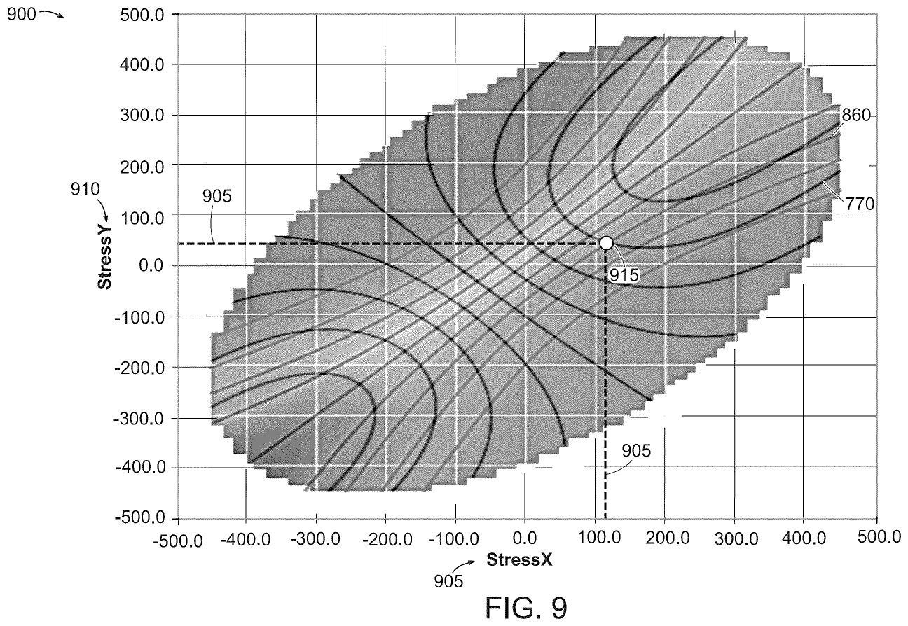

FIG. 9 is an exemplary full calibration map 900 for a specimen being inspected. The map 900 is an overlay of the predetermined/interpolated biaxial average stress calibration map 700 and the predetermined/interpolated biaxial peak-to-peak stress map 800. In some aspects, a plurality of biaxial stress maps, similar to maps 700, 800 and 900 can be stored in the memory of the system for the plurality of known materials/material grades. Similar to map 700, the system can be configured to generate the map 800 for the pipe based on the predetermined/interpolated peak-to-peak stress calibration determined using the linkage/leakage peak-to-peak parameters determined and the library of calibration data, as described above in reference to FIG. 6. As shown in FIG. 9, the map 900 can include a first principal axis 905 (e.g., “Stress X”) and a second principal axis 910 (e.g., “Stress Y”), which are the same as the first principal axes 705, 805 and the second principal axes 710, 810 of FIGS. 7 and 8, respectively. In some aspects, to determine the biaxial stress along the principal stress axes 905, 910 at that point in the pipe, the system can be configured to determine a point 915 at which the contour line determined from the predetermined/interpolated biaxial average stress calibration map 700 intersects with the contour line of the predetermined/interpolated biaxial peak-to-peak stress calibration map 800. For example, furthering the example described above in reference to FIGS. 4-8, the system can be configured to determine that the contour line 770 determined from the predetermined/interpolated biaxial average stress calibration map 700 intersects with the contour line 860 of the predetermined/interpolated biaxial peak-to-peak stress calibration map 800 at the point 915. Based on the point 915, the system can determine that the bi-axial stress at that point in the pipe includes a stress of about 120 MPa along the first principal axis 905 (e.g., principal stress axis 435 of FIG. 4), and a stress of about 40 MPa along the second principal axis 910 (e.g., principal stress axis 440 of FIG. 4).

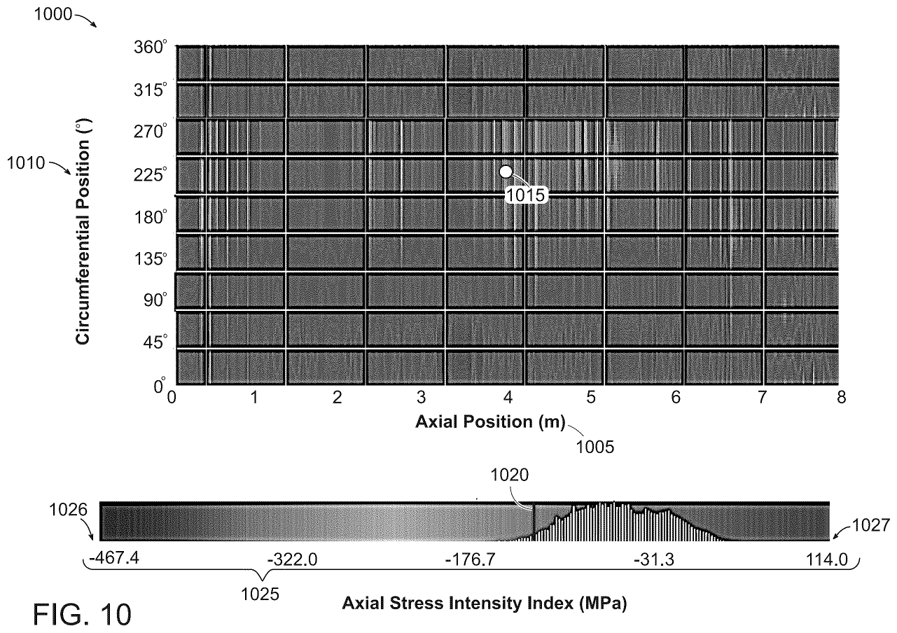

FIG. 10 is an exemplary interactive axial stress map 1000 characterizing axial stress along a portion of the surface specimen being inspected (e.g., pipe 101 of FIG. 1). In some aspects, the interactive axial stress map 1000 can be provided to a user interface (UI) display of the system to be viewed by a user. As shown in FIG. 10, if the specimen being inspected is a pipeline, the interactive axial stress map 1000 includes a first axis 1005 defining an axial position along a portion of the pipeline being inspected (e.g., a span of 8 m of pipe within the pipeline) and a second axis 1010 defining a circumferential position around a circumference of the pipeline (e.g., from 0-360 degrees). Accordingly, each position (e.g., point 1015) on the map 1000 corresponds to an (axial, circumferential) coordinate along the portion of the pipeline being inspected and the axial stress intensity (e.g., in MPa) for the point 1015 can be determined by matching the color of the point 1015 to a corresponding stress 1020 in the axial stress index 1025. In some aspects, the axial stress index 1025 can have a range defined based on the stress range determined by the system based on the material properties (e.g., the range defined by the first principal axis 705, 805, 905 and the second principal axis 710, 810, 910 of FIGS. 7-9, respectively). In some aspects, the range of the axial stress index 1025 can be displayed by auto-sizing the stress range to only include a range of stresses defined by a minimum stress 1026 and a maximum stress 1027 determined for that portion of the pipeline being inspected.

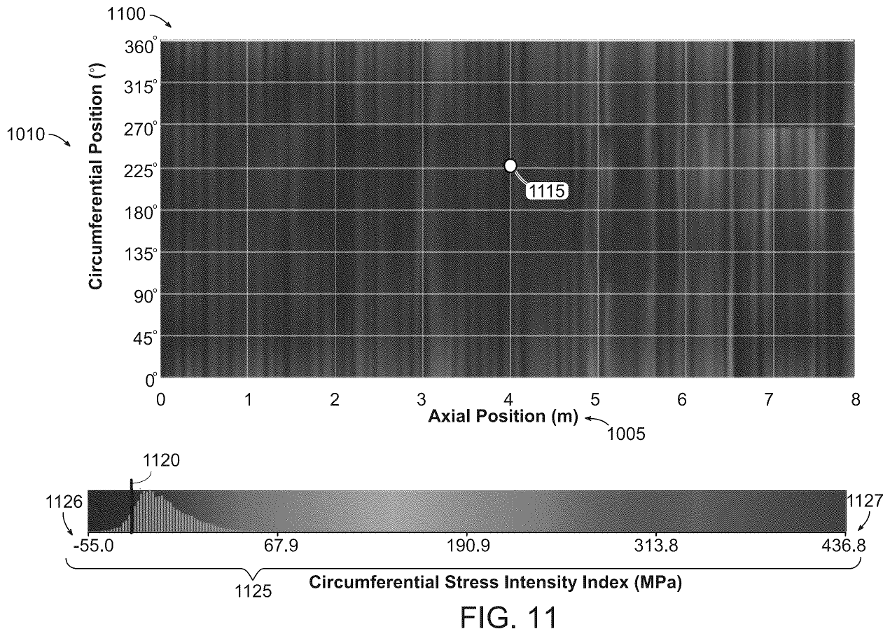

Similarly, FIG. 11 is an exemplary interactive circumferential stress map 1100 characterizing circumferential stress along the portion of the surface specimen being inspected (e.g., pipe 101 of FIG. 1). In some aspects, the interactive circumferential stress map 1100 can be provided to a user interface (UI) display of the system to be viewed by a user. As shown in FIG. 11, the interactive circumferential stress map 1100 includes the same first axis 1005 and second axis 1010 of FIG. 10, defining the axial position along the portion of the pipeline being inspected (e.g., a span of 8 m of pipe) and the circumferential position around a circumference of the pipeline (e.g., from 0-360 degrees), respectively. Accordingly, each position (e.g., point 1115) on the map 1100 corresponds to the same (axial, circumferential) coordinate as point 1015 of FIG. 10 along the portion of the pipeline being inspected and the circumferential stress intensity (e.g., in MPa) for the point 1115 can be determined by matching the color of the point 1115 to a corresponding stress 1120 in the circumferential stress index 1125. Similarly to as described above, in some aspects, the circumferential stress index 1125 can have a range defined based on the stress range determined by the system based on the material properties (e.g., the range defined by the first principal axis 705, 805, 905 and the second principal axis 710, 810, 910 of FIGS. 7-9, respectively). In some aspects, the range of the circumferential stress index 1125 can be displayed by auto-sizing the stress range to only include a range of stresses defined by a minimum stress 1126 and a maximum stress 1127 determined for that portion of the pipeline being inspected.

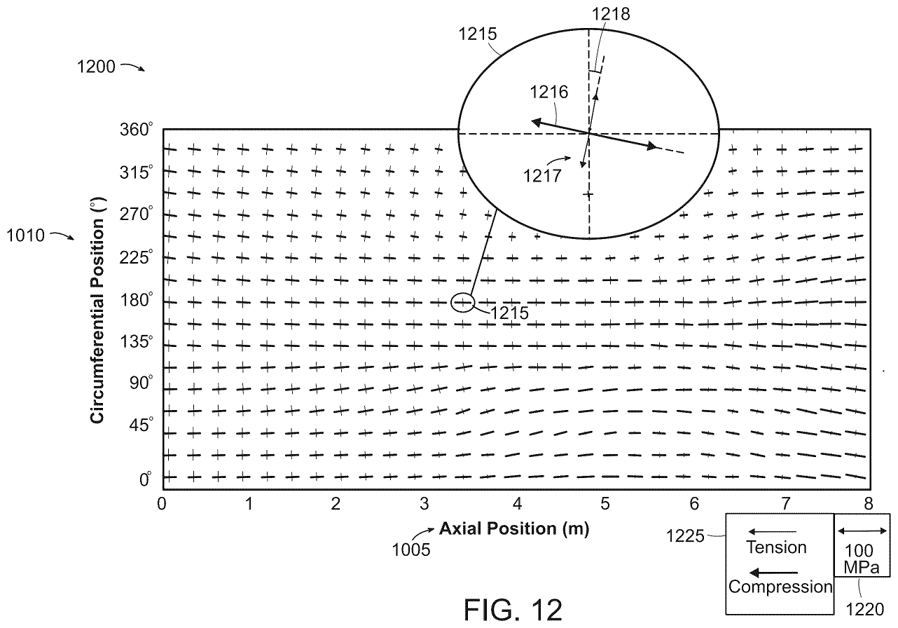

FIG. 12 is an exemplary interactive bi-axial stress map 1200 characterizing bi-axial stress along the portion of the surface specimen being inspected (e.g., pipe 101 of FIG. 1). In some aspects, the interactive bi-axial stress map 1200 can be provided to a user interface (UI) display of the system to be viewed by a user. As shown in FIG. 12, the interactive bi-axial stress map 1200 can include the same first axis 1005 and second axis 1010 of FIGS. 10-11, defining the axial position along the portion of the pipeline being inspected (e.g., a span of 8 m of pipe) and the circumferential position around a circumference of the pipeline (e.g., from 0-360 degrees), respectively. However, the bi-axial stress map 1200 intuitively displays the axial stress, the circumferential stress and the principal stress axes for a plurality of points (e.g., including a point 1215) along the portion of the pipeline being inspected, such that a user can intuitively determine the bi-axial stress and stress axes for a given point in the pipeline. For example, each point of the plurality of points along the portion of the pipeline being inspected (e.g., point 1215) can include an axial stress vector 1216 and a circumferential stress vector 1217, as shown in the magnified portion of the map 1215′. Additionally, each point 1215 can include one or more angles 1218 which define an offset of the principal stress axes (e.g., principal stress axes 435, 440, determined during the cosine fitting operation 400) for the bi-axial stress at each point 1215. The bi-axial stress map 1200 can also include a stress scale 1220 defining a relationship between the lengths of the stress vectors 1216, 1217 and a magnitude of stress. The bi-axial stress map 1200 can also include a stress legend 1225 defining tensile stresses and compressive stress. For example, as shown in FIG. 12, tensile stresses can be illustrated by a green stress vector and compressive stresses can be illustrated by a red stress vector, however, other color schematics are also realized. In some aspects, a user can be permitted to zoom in on the bi-axial stress map 1200, and the map can be configured to update to show more detailed stress vectors for the zoomed portion.

In some aspects, the non-material-specific lift responses for the linkage and leakage sensors, as described above in reference to FIGS. 2 and 4, can also be used by the system to determine irregularities in the surface of the specimen being inspected. For example, in some aspects, the systems and methods described herein can be configured to use the non-material-specific lift responses for the linkage and leakage sensors acquired during the inspection to generate interactive maps similar to those depicted in FIGS. 10-11 to intuitively illustrate changes in distance (e.g., in microns) from the plurality of probes to the surface of the specimen.

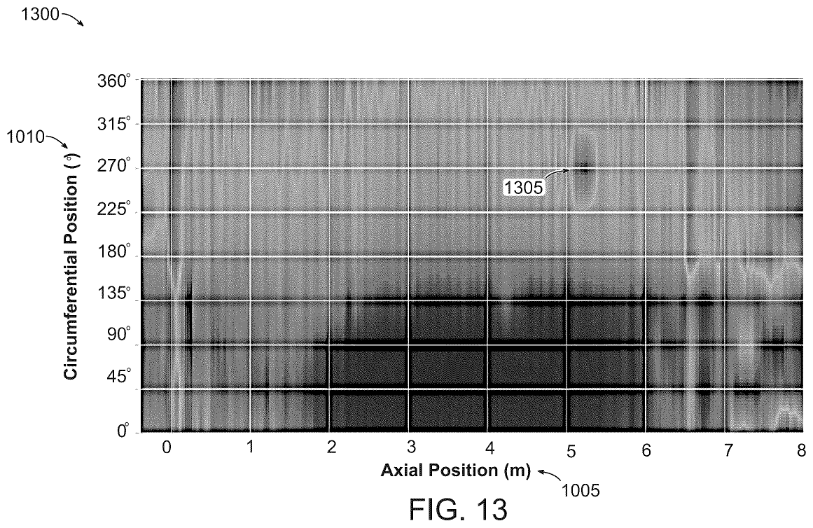

For example, FIG. 13 is an exemplary interactive lift map 1300 characterizing changes in distance (e.g., in microns) from the plurality of probes to the surface of the pipe. In some aspects, the interactive circumferential stress map 1300 can be provided to a user interface (UI) display of the system to be viewed by a user. As shown in FIG. 13, the interactive lift map 1300 includes the same first axis 1005 and second axis 1010 of FIGS. 10-11, defining the axial position along the portion of the pipeline being inspected (e.g., a span of 8 m of pipe) and the circumferential position around a circumference of the pipeline (e.g., from 0-360 degrees), respectively. Accordingly, each position on the map 1300 corresponds to an (axial, circumferential) coordinate along the portion of the pipeline being inspected. The map 1300 advantageously provides the user with an intuitive visual representation of the changes in distance from the plurality of probes to the surface of the pipe, which can be used to determine defects within the pipe (e.g., corrosion, cracking, deposits, etc.). For example, as shown in the map 1300, the area 1305 of the map 1300 can indicate to the user that there may be corrosion (e.g., material loss) at that point in the pipe, based on the change in distance from the probes to that area 1305, relative to other areas in the pipe.

In some aspects, the maps 700-1300 can be provided to the user in full color such that the user can intuitively visualize areas of compression and tension within the specimen being inspected. For example, in some aspects, the color scheme of the maps 700-1300 can range from blue to purple, where blue indicates areas of high compression and purple indicates areas of high tension, with other colors provided in between to depict the range of stress in the specimen.

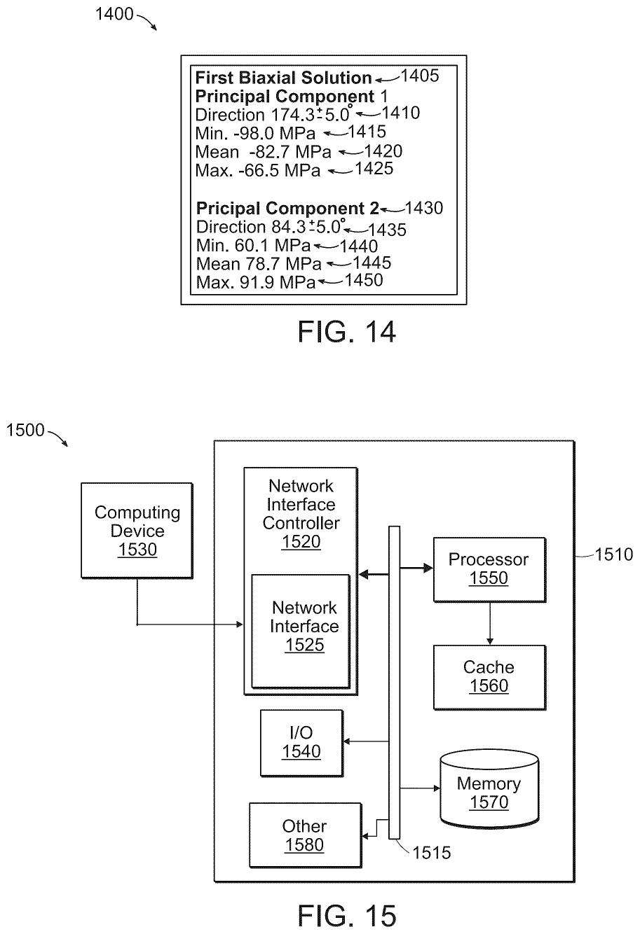

FIG. 14 is an exemplary stress table 1400 that can also be provided to the user interface (UI) display of the system to be viewed by the user. For example, in some aspects, based on the axial and circumferential stresses determined for the portion of the pipe in FIGS. 10-11, respectively, the system can also be configured to generate a corresponding stress table 1400 which can provide quantitative information pertaining to the stress at that portion in the pipe. As portion of a pipe being inspected. As shown in FIG. 14, the stress table 1400 can include a first bi-axial stress solution 1405 characterizing the axial stress for that portion of the pipe. In some aspects, the first bi-axial stress solution 1405 can include a first principal stress axis 1410, having an uncertainty determined based on the range of principal stress axes determined for each point in that portion of the pipe (e.g., the principal stress axes 435 determined for each point in the pipe during the cosine fitting operation 400 of FIG. 4). The first bi-axial stress solution 1405 can also include minimum, average and maximum stresses 1415, 1420, 1425, respectively, along the first principal stress axis 1410 for that portion of the pipe. Similarly, the stress table 1400 can include a second bi-axial stress solution 1430 characterizing the circumferential stress for that portion of the pipe. In some aspects, the second bi-axial stress solution 1430 can include a second principal stress axis 1435, having an uncertainty determined based on the range of principal stress axes determined for each point in that portion of the pipe (e.g., the principal stress axes 440 determined for each point in the pipe during the cosine fitting operation 400 of FIG. 4). The second bi-axial stress solution 1430 can also include minimum, average and maximum stresses 1440, 1445, 1450, respectively, along the second principal stress axis 1430 for that portion of the pipe.

FIG. 15 is a block diagram 1500 of a computing system 1510 suitable for use in implementing the computerized components described herein, such as the system 100 of FIG. 1. In broad overview, the computing system 1510 includes at least one processor 1550 for performing actions in accordance with instructions, and one or more memory devices 1560 and/or 1570 for storing instructions and data. The illustrated example computing system 1510 includes one or more processors 1550 in communication, via a bus 1515, with memory 1570 and with at least one network interface controller 1520 with a network interface 1525 for connecting to external devices 1530, e.g., a computing device. The one or more processors 1550 are also in communication, via the bus 1515, with each other and with any I/O devices 1530 at one or more I/O interfaces 1530, and any other devices 1580. The processor 1550 illustrated incorporates, or is directly connected to, cache memory 1560. Generally, a processor will execute instructions received from memory. In some aspects, the computing system 1510 can be configured within a cloud computing environment, a virtual or containerized computing environment, and/or a web-based microservices environment.

In more detail, the processor 1550 can be any logic circuitry that processes instructions, e.g., instructions fetched from the memory 1570 or cache 1560. In many aspects, the processor 1550 is an embedded processor, a microprocessor unit or special purpose processor. The computing system 1510 can be based on any processor, e.g., suitable digital signal processor (DSP), or set of processors, capable of operating as described herein. In some aspects, the processor 1550 can be a single core or multi-core processor. In some aspects, the processor 1550 can be composed of multiple processors.

The memory 1570 can be any device suitable for storing computer readable data. The memory 1570 can be a device with fixed storage or a device for reading removable storage media. Examples include all forms of non-volatile memory, media and memory devices, semiconductor memory devices (e.g., EPROM, EEPROM, SDRAM, flash memory devices, and all types of solid state memory), magnetic disks, and magneto optical disks. A computing device 1510 can have any number of memory devices 1570.

The cache memory 1560 is generally a form of high-speed computer memory placed in close proximity to the processor 1550 for fast read/write times. In some implementations, the cache memory 1560 is part of, or on the same chip as, the processor 1550.

The network interface controller 1520 manages data exchanges via the network interface 1525. The network interface controller 1520 handles the physical, media access control, and data link layers of the Open Systems Interconnect (OSI) model for network communication. In some implementations, some of the network interface controller's tasks are handled by the processor 1550. In some implementations, the network interface controller 1520 is part of the processor 1550. In some implementations, a computing device 1510 has multiple network interface controllers 1520. In some implementations, the network interface 1525 is a connection point for a physical network link, e.g., an RJ 45 connector. In some implementations, the network interface controller 1520 supports wireless network connections via network interface port 1525. Generally, a computing device 1510 exchanges data with other network devices 1530, such as computing device 1530, via physical or wireless links to a network interface 1525. In some implementations, the network interface controller 1520 implements a network protocol such as LTE, TCP/IP Ethernet, IEEE 802.11, IEEE 802.16, or the like.

The other computing devices 1530 are connected to the computing device 1510 via a network interface port 1525. The other computing device 1530 can be a peer computing device, a network device, or any other computing device with network functionality. For example, a computing device 1530 can be a remote controller, or a remote display device configured to communicate and operate the system 100 remotely. In some aspects, a computing device 1530 can include a server or a network device such as a hub, a bridge, a switch, or a router, connecting the computing device 1510 to a data network such as the Internet.

In some uses, the I/O interface 1530 supports an input device and/or an output device (not shown). In some uses, the input device and the output device are integrated into the same hardware, e.g., as in a touch screen. In some uses, such as in a server context, there is no I/O interface 1530 or the I/O interface 1530 is not used. In some uses, additional other components 1580 are in communication with the computer system 1510, e.g., external devices connected via a universal serial bus (USB).

The other devices 1580 can include an I/O interface 1540, external serial device ports, and any additional co-processors. For example, a computing system 1510 can include an interface (e.g., a universal serial bus (USB) interface, or the like) for connecting input devices (e.g., a keyboard, microphone, mouse, or other pointing device), output devices (e.g., video display, speaker, refreshable Braille terminal, or printer), or additional memory devices (e.g., portable flash drive or external media drive). In some implementations an I/O device is incorporated into the computing system 1510, e.g., a touch screen on a tablet device. In some implementations, a computing device 1510 includes an additional device 1580 such as a co-processor, e.g., a math co-processor that can assist the processor 1550 with high precision or complex calculations.

Certain exemplary aspects have been described to provide an overall understanding of the principles of the structure, function, manufacture, and use of the systems, devices, and methods disclosed herein. One or more examples of these aspects have been illustrated in the accompanying drawings. Those skilled in the art will understand that the systems, devices, and methods specifically described herein and illustrated in the accompanying drawings are non-limiting exemplary aspects and that the scope of the present invention is defined solely by the claims. The features illustrated or described in connection with one exemplary aspect may be combined with the features of other aspects. Such modifications and variations are intended to be included within the scope of the present invention. Further, in the present disclosure, like-named components of the aspects generally have similar features, and thus within a particular aspect each feature of each like-named component is not necessarily fully elaborated upon.

The subject matter described herein can be implemented in analog electronic circuitry, digital electronic circuitry, and/or in computer software, firmware, or hardware, including the structural means disclosed in this specification and structural equivalents thereof, or in combinations of them. The subject matter described herein can be implemented as one or more computer program products, such as one or more computer programs tangibly embodied in an information carrier (e.g., in a machine-readable storage device), or embodied in a propagated signal, for execution by, or to control the operation of, data processing apparatus (e.g., a programmable processor, a computer, or multiple computers). A computer program (also known as a program, software, software application, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file. A program can be stored in a portion of a file that holds other programs or data, in a single file dedicated to the program in question, or in multiple coordinated files (e.g., files that store one or more modules, sub-programs, or portions of code). A computer program can be deployed to be executed on one computer or on multiple computers at one site or distributed across multiple sites and interconnected by a communication network.

The processes and logic flows described in this specification, including the method steps of the subject matter described herein, can be performed by one or more programmable processors executing one or more computer programs to perform functions of the subject matter described herein by operating on input data and generating output. The processes and logic flows can also be performed by, and apparatus of the subject matter described herein can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processor of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, (e.g., EPROM, EEPROM, and flash memory devices); magnetic disks, (e.g., internal hard disks or removable disks); magneto-optical disks; and optical disks (e.g., CD and DVD disks). The processor and the memory can be supplemented by, or incorporated in, special purpose logic circuitry.

To provide for interaction with a user, the subject matter described herein can be implemented on a computer having a display device, e.g., a touch-screen display, a cathode ray tube (CRT) or liquid crystal display (LCD) monitor, for receiving inputs and for displaying information to the user and a keyboard and a pointing device, (e.g., a mouse or a trackball), by which the user can provide input to the computer. Other kinds of devices can be used to provide for interaction with a user as well. For example, feedback provided to the user can be any form of sensory feedback, (e.g., visual feedback, auditory feedback, or tactile feedback), and input from the user can be received in any form, including acoustic, speech, or tactile input.

The techniques described herein can be implemented using one or more modules. As used herein, the term “module” refers to computing software, firmware, hardware, and/or various combinations thereof. At a minimum, however, modules are not to be interpreted as software that is not implemented on hardware, firmware, or recorded on a non-transitory processor readable recordable storage medium (i.e., modules are not software per se). Indeed “module” is to be interpreted to always include at least some physical, non-transitory hardware such as a part of a processor or computer. Two different modules can share the same physical hardware (e.g., two different modules can use the same processor and network interface). The modules described herein can be combined, integrated, separated, and/or duplicated to support various applications. Also, a function described herein as being performed at a particular module can be performed at one or more other modules and/or by one or more other devices instead of or in addition to the function performed at the particular module. Further, the modules can be implemented across multiple devices and/or other components local or remote to one another. Additionally, the modules can be moved from one device and added to another device, and/or can be included in both devices.

The subject matter described herein can be implemented in a computing system that includes a back-end component (e.g., a data server), a middleware component (e.g., an application server), or a front-end component (e.g., a client computer having a graphical user interface or a web browser through which a user can interact with an implementation of the subject matter described herein), or any combination of such back-end, middleware, and front-end components. The components of the system can be interconnected by any form or medium of digital data communication, e.g., a communication network. Examples of communication networks include a local area network (“LAN”) and a wide area network (“WAN”), e.g., the Internet.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

One skilled in the art will appreciate further features and advantages of the invention based on the above-described aspects. Accordingly, the present application is not to be limited by what has been particularly shown and described, except as indicated by the appended claims. All publications and references cited herein are expressly incorporated by reference in their entirety.

1. An inspection system comprising:
one or more magnetic probes configured to acquire stress data characterizing a plurality of stress measurements at a plurality of points along a surface of a specimen, wherein the stress data is acquired at a plurality of angles for each of the plurality of points; and
a computing system communicatively coupled to the one or more magnetic probes, the computing system including at least one data processor and a memory storing material data characterizing a plurality of predetermined material calibration parameters and material properties for a plurality of materials and computer-readable instructions which, when executed by the at least one processor, cause the at least one processor to perform operations comprising:
receiving, from the one or more magnetic probes, stress data characterizing a plurality of stress measurements along the surface of the specimen;
comparing the stress data to the material data;
determining material properties of the specimen based on the comparing; and
providing the material properties of the specimen to a user interface display communicatively coupled to the computing system.

2. The inspection system of claim 1, wherein the specimen is a pipeline made from a ferromagnetic material, the inspection system further comprising:
an in-line inspection unit configured to move along the pipeline, wherein the one or more magnetic probes are coupled to the in-line inspection unit.

3. The inspection system of claim 2, wherein the one or more magnetic probes include a plurality of probes configured to acquire stress measurements across a range of at least 90 degrees.

4. The inspection system of claim 2, wherein the one or more magnetic probes include a singular probe configured to rotate at least 90 degrees and acquire stress measurements at a plurality of angles along the surface of the pipeline.

5. The inspection system of claim 1, wherein each of the one or more magnetic probes comprise a magnetic flux linkage sensor configured to measure magnetic flux and a magnetic leakage sensor configured to measure magnetic leakage.

6. The inspection system of claim 1, wherein the material data includes calibration data characterizing magnetic permeability and coercivity for each of the plurality of materials as a function of stress and a plurality of calibration stress measurements from the plurality of materials acquired across a known range of stresses, a known range of probe frequencies and a known range of probe distances.

7. The inspection system of claim 6, wherein the operations further comprise:
determining a plurality of stress calibration parameters for the stress data based on the material data and the determined material properties;
generating one or more interactive bi-axial stress maps characterizing bi-axial stress along the surface specimen based on the plurality of stress calibration parameters and the stress data; and
providing the one or more interactive bi-axial stress maps to the user interface display.

8. The inspection system of claim 7, wherein the operations further comprise:
determining a plurality of principal stress axes for a plurality of positions along the surface of the specimen based on the plurality of stress calibration parameters.

9. The inspection system of claim 8, wherein the one or more interactive stress maps include data representative of the plurality of principal stress axes for a plurality of positions along the surface of the specimen based on the plurality of stress calibration parameters.

10. The inspection system of claim 8, wherein the operations further comprise:
determining minimum, average and maximum biaxial stresses for a portion of the specimen being inspected; and
providing a stress table to the user interface display, wherein the stress table comprises data characterizing the minimum, average and maximum biaxial stresses for the portion of the specimen and global principal stress axes characterizing a range of the plurality of principal stress axes for the plurality of positions along the surface of the specimen.

11. A method comprising:
acquiring, by one or more magnetic probes, stress data characterizing a plurality of stress measurements at a plurality of points along a surface of a specimen, wherein the stress data is acquired at a plurality of angles for each of the plurality of points;
receiving the stress data by a computing system including at least one data processor and a memory storing material data characterizing a plurality of predetermined material properties for a plurality of materials and computer-readable instructions which, when executed by the at least one processor, cause the at least one processor to perform operations;
comparing, by the at least one data processor, the stress data to the material data;
determining, by the at least one data processor, material properties of the specimen based on the comparing; and
providing, by the at least one data processor, the material properties of the specimen to a user interface display communicatively coupled to the computing system.

12. The method of claim 11, wherein the specimen is a pipeline made from a ferromagnetic material, the method further comprising:
deploying an in-line inspection unit into the pipeline, wherein the in-line inspection unit is configured to move along the pipeline during an inspection and wherein the one or more magnetic probes are coupled to the in-line inspection unit.

13. The method of claim 12, wherein the one or more magnetic probes include a plurality of probes configured to acquire stress measurements across a range of at least 90 degrees along the surface of the pipeline.

14. The method of claim 12, wherein the one or more magnetic probes include a singular probe configured to rotate at least 90 degrees and acquire stress measurements at a plurality of angles along the surface of the pipeline.

15. The method of claim 11, wherein each of the one or more magnetic probes comprise a magnetic flux linkage sensor configured to measure magnetic flux and a magnetic leakage sensor configured to measure magnetic leakage.

16. The method of claim 11, wherein the material data includes calibration data characterizing magnetic permeability and coercivity for each of the plurality of materials as a function of stress and a plurality of calibration stress measurements from the plurality of materials acquired across a known range of stresses, a known range of probe frequencies and a known range of probe distances.

17. The method of claim 16, further comprising:
determining, by the at least one data processor, a plurality of stress calibration parameters for the stress data based on the material data and the determined material properties;
generating, by the at least one data processor, one or more interactive stress maps characterizing stress along the surface specimen based on the plurality of stress calibration parameters and the stress data; and
providing, by the at least one data processor, the one or more interactive stress maps to the user interface display.

18. The method of claim 17, further comprising:
determining, by the at least one data processor, a plurality of principal stress axes for a plurality of positions along the surface of the specimen based on the plurality of stress calibration parameters.

19. The method of claim 18, wherein the one or more interactive stress maps include data representative of the plurality of principal stress axes for a plurality of positions along the surface of the specimen based on the plurality of stress calibration parameters.

20. The method of claim 18, further comprising:
determining, by the at least one data processor, minimum, average and maximum biaxial stresses for a portion of the specimen being inspected; and
providing, by the at least one data processor, a stress table to the user interface display, wherein the stress table comprises data characterizing the minimum, average and maximum biaxial stresses for the portion of the specimen and global principal stress axes characterizing a range of the plurality of principal stress axes for the plurality of positions along the surface of the specimen.
